(19) United States
(12) Patent Application Publication
(10) Pub. No.: US 2025/0282297 A1
(43) Pub. Date: Sep. 11, 2025

(54) ATTACHMENT UNIT

(71) Applicant: ACPS Automotive GmbH, Ingersheim (DE)

(72) Inventors: Lars Schneider, Korntal-Münchingen (DE); Martin Krause, Möglingen (DE)

(73) Assignee: ACPS Automotive GmbH, Ingersheim (DE)

(21) Appl. No.: 19/074,729

(22) Filed: Mar. 10, 2025

(30) Foreign Application Priority Data
Mar. 11, 2024 (DE) 10 2024 106 825.6
Apr. 25, 2024 (DE) 10 2024 111 707.9

(51) Int. Cl. B60R 9/06; B60D 1/52; B60D 1/54

(52) U.S. Cl. CPC B60R 9/06; B60D 1/52; B60D 1/54; B60D 2001/544

(57) ABSTRACT

In order to improve an attachment unit such that it is on the one hand of simple construction and on the other as far as possible universally usable, it is proposed that on movement from the working position into the rest position and vice versa the receiving body should move parallel to a movement plane and maintain a constant orientation of the center axis of the insertion receptacle transverse to the movement plane, and that the movement plane should run transversely to a vertical longitudinal center plane.

### CROSS-REFERENCE TO RELATED PATENT APPLICATIONS

The present disclosure relates to the subject matter disclosed in German application number 10 2024 106 825.6 of 11 Mar. 2024 and German application number 10 2024 111 707.9 of 25 Apr. 2024, which are incorporated herein by reference in their entirety and for all purposes.

### BACKGROUND OF THE INVENTION

The invention relates to an attachment unit that is mountable on a rear region of a body of a motor vehicle, comprising a bearing unit, which is mountable in a manner fixed to the vehicle on the rear region of the motor vehicle, in particular a passenger car, by a carrier unit, and by which a receiving body that comprises an insertion receptacle is held on the carrier unit and is mounted such that it is movable between a working position and a rest position, wherein in the working position the insertion receptacle extends with its center axis approximately parallel to a vertical longitudinal center plane of the attachment unit.

Attachment units of this kind are known from the prior art, wherein the insertion receptacles always serve to receive a holding arm which carries either a coupling element for a trailer, for example a coupling ball, or a load carrier such as a bicycle carrier.

A holding arm of this kind is insertable into and fixable in the insertion receptacle, wherein, for the purpose of moving the receiving body with the insertion receptacle from the working position into the rest position, a holding arm of this kind is removable from the insertion receptacle.

The known solutions cannot be used with all vehicles because of the spatial conditions and space taken up, in particular the space taken up between the rear region of the motor vehicle and a bumper unit.

In accordance with an embodiment of the invention, an attachment unit of the kind mentioned in the introduction is improved such that it is on the one hand of simple construction and on the other as far as possible universally usable.

### SUMMARY OF THE INVENTION

In accordance with an embodiment of the invention, provision is made in the case of an attachment unit of the kind mentioned in the introduction that on movement from the working position into the rest position and vice versa the receiving body moves parallel to a movement plane and maintains a constant orientation of the center axis of the insertion receptacle transverse to the movement plane, and that the movement plane runs transversely to a vertical longitudinal center plane.

This provides the possibility of making the bearing unit with the receiving body and the insertion receptacle compact, and thus taking up a small space even while they are moving from the working position into the rest position.

As regards the orientation of the movement plane in relation to the vertical longitudinal center plane, it is particularly advantageous if the movement plane forms an angle in the range between 90° and 60° with one of the sides of the vertical longitudinal center plane, such that the space taken up for the pivotal movement parallel to the movement plane can be kept small.

It is particularly advantageous here if the movement plane forms an angle in the range of from 90° to 65°, or better in the range of from 90° to 70° and preferably in the range of from 90° to 75° or particularly favorably in the range of from 90° to 80°, with one of the sides of the vertical longitudinal center plane.

Here, the vertical longitudinal center plane is defined by the fact that it runs parallel to a vertical longitudinal center plane of the body of the motor vehicle and thus, when a motor vehicle is standing on a horizontal road, passes centrally through the body in the longitudinal direction, running vertically.

Likewise, the vertical longitudinal center plane of the attachment unit is to be defined such that it passes centrally through the attachment unit in its longitudinal direction, which coincides with the longitudinal direction of the motor vehicle, and runs vertically when a motor vehicle is standing on a horizontal road.

In particular, a vertical longitudinal center plane of this kind runs in an X and a Z direction of the body of the motor vehicle and thus also in an X and a Z direction of the attachment unit.

Moreover, it is preferably provided for the movement plane to run transversely to a horizontal longitudinal plane and thus in particular transversely to the vertical longitudinal center plane and transversely to the horizontal longitudinal plane.

The term “horizontal longitudinal plane” here is to be understood to mean a plane which, when a motor vehicle is standing on a horizontal road, runs horizontally and in the longitudinal direction of the motor vehicle.

In terms of the coordinate system of the body, a horizontal longitudinal plane of this kind runs parallel to the X axis and the Y axis.

Here, it is particularly favorable if the movement plane forms an angle in the range of from 90° to 60° with one of the sides of the horizontal longitudinal plane, in order likewise to determine a primary transverse orientation of the movement plane in relation to the longitudinal plane.

It is particularly favorable if the angle is in the range of from 90° to 65°, or better in the range of from 90° to 70° and preferably in the range of from 90° to 75°, or better in the range of from 90° to 80°.

It is particularly favorable here if the receiving body is movable from the working position into the rest position and vice versa only parallel to the movement plane, such that as a result simple kinematics is usable for the movement of the receiving body between the working position and the rest position.

It has been found to be particularly favorable if the bearing unit comprises a guide unit that determines a track for the receiving body between the working position and the rest position that runs parallel to the movement plane.

In order to be able to immobilize the receiving body in the working position, it is favorably provided for the bearing unit to have a fixing device by which the receiving body is fixable in the working position relative to the carrier unit.

Moreover, in order also to be able to immobilize the receiving body in the rest position, it is provided for the bearing unit to have a fixing device by which the receiving body is fixable in the rest position relative to the carrier unit.

In order to be able to optimally exploit the solution according to the invention with all its advantages, it is provided for the attachment unit to have a bumper unit, which covers the carrier unit and the bearing unit on a side facing away from the rear region of the body and which has a bumper lower edge facing a road, and for the insertion receptacle to be arranged, in the working position, on a side of the lower edge of the bumper unit that faces the road.

This solution ensures that the holding arm for insertion into the insertion receptacle can be inserted in a simple manner.

In particular here, it is favorably provided for the insertion receptacle to be arranged as close as possible to the lower edge of the bumper unit, in order not to impair the ground clearance of the motor vehicle.

The solution according to the invention is particularly advantageous if the insertion receptacle is arranged, in the rest position, on a side of the bumper lower edge that faces away from the road and is thus hidden from view by the bumper unit, such that in the rest position of the insertion receptacle both this and the receiving body having the insertion receptacle are invisible.

In order to move the receiving body from the working position into the rest position, it is favorably provided for the receiving body, on movement from the working position into the rest position and vice versa, to be movable through a free space between the bumper lower edge and the rear region.

In this case, an uninterrupted free space is usually provided between the bumper unit arranged facing away from the rear region and the rear region.

Another solution of even more attractive appearance provides for the bumper unit to have a lower wall which runs from the lower edge thereof to the rear region and is provided with an opening through which the receiving body, with the insertion receptacle, is movable on movement from the working position into the rest position or vice versa.

In order to enable movement of the receiving body, with the insertion receptacle, to be advantageously achieved, it is preferably provided for the bearing unit to comprise a pivotal unit of which the pivot axis is oriented perpendicular to the movement plane, such that during a pivotal movement about the pivot axis a movement of the receiving body, with the insertion receptacle, can be achieved in a simple manner parallel to the movement plane and in particular only parallel to the movement plane.

As regards the form taken by the pivotal unit, the most diverse solutions are conceivable.

A particularly advantageous embodiment here provides for the pivotal unit to have a pivot bearing unit and a pivotal element that is pivotal relative to this about the pivot axis on which the receiving body is held.

Preferably in this case, the receiving body is connected to the pivotal element either directly or by a connection element.

In order to be able to fix the receiving body in the working position and where appropriate also in the rest position in a simple manner, it is preferably provided for a fixing device to be associated with the pivot bearing unit, in particular to be integrated into it.

A fixing device of this kind thus provides the possibility of being able to achieve reliable fixing in both the working position and the rest position.

An advantageous solution of a fixing device of this kind provides for it to take the form of a rotation-blocking device.

For example, a fixing device of this kind takes a form such that it has at least one rotation-blocking body that is movable in a guide direction having at least one component in the radial direction in relation to the pivot axis, wherein as a result of movement in the guide direction the at least one rotation-blocking body is engageable with and disengageable from at least one receptacle, and wherein an actuation body that is movable in an actuation direction is provided, the movement of which in the actuation direction is configured to move and urge the at least one rotation-blocking body in the guide direction, in order to move the rotation-blocking body between at least one rotation-blocking position and a free-running position.

It is particularly favorable here if, during its movement in the guide direction, the rotation-blocking body is guided by guiding receptacles in a guide body.

In particular here, a unit is formed by the guide body and the actuation body with the at least one rotation-blocking body, while the receptacle is provided in the unit of the fixing device that is rotatable in relation to this unit.

Thus, it is possible to fix the working position and the rest position in a simple manner using a fixing device of this kind.

For this purpose, it is for example provided for the pivot bearing unit to be provided with a drive unit for actuating the fixing device.

Moreover, it is preferably provided for the pivot bearing unit to be provided with a drive unit for performing the pivotal movement of the pivotal element.

A further advantageous solution provides for the bearing unit to have a non-pivotal guide unit for moving the receiving body along a track parallel to the movement plane.

For example, in this case the guide unit takes the form of a linear guide.

A solution that is particularly simple to achieve provides here for the guide unit to have a threaded spindle as the driving element.

A further advantageous solution provides for the guide unit to be provided with a fixing device.

Here, it is particularly favorable if the fixing device has a threaded spindle that is configured to be self-locking.

A further advantageous solution provides for the receiving body to have at least two receiving body parts, and for the receiving body parts to together make up the receiving body in the working position.

This solution has the advantage that when the receiving body parts together make up the receiving body, the receiving body is advantageously already blockable in the working position when the holding arm is inserted.

In particular here, it is provided for the receiving body parts to be movable parallel to the movement plane along different guide tracks.

Here, the guide tracks may be either linear guide tracks or indeed circular tracks, such that for example the receiving body parts may also be pivoted into the working position from different sides, or may be moved linearly in the direction of the working position from different sides.

Favorably, in this case the receiving body parts are movable into different rest positions in order to enable them to be put into positions in which they lie on a side of the lower edge of the bumper unit that faces away from the road.

Preferably here, the receiving body parts are movable into the different rest positions starting from the working position.

No statements have been made in the context of the above explanation of the solution according to the invention as regards further elements of the attachment unit that are to be provided.

A particularly preferred solution provides for a plug connector unit to be held on the receiving body.

In particular here, it is provided for the plug connector unit, with the receiving body, to be movable from a working position into a rest position, wherein in this case, in the rest position the plug connector unit is favorably likewise on a side of the lower edge of the bumper unit that faces away from the road.

Favorably, it is further provided for the plug connector unit to have an insertion direction for a plug connector which runs transversely, for example perpendicular or indeed obliquely, to the movement plane, such that in this case insertion of the plug connector is facilitated in a simple manner, but on the other hand, in the working position, the plug connector unit may also lie for example as a whole on a side of the lower edge of the bumper unit that faces the road or may also already lie at least in part on a side of the lower edge of the bumper unit that faces away from the road.

In particular here, it is provided for the plug connector unit to have an insertion opening which, in the working position, lies on a side of the lower edge of the bumper unit that faces the road.

This can be achieved in a particularly favorable manner if, in the working position, the plug connector unit extends away from the insertion opening in the direction of the road.

In particular, it is provided for the plug connector unit to be arranged, in the rest position, on a side of the lower edge of the bumper unit that faces away from the road.

Thus, the above description of solutions according to the invention comprises in particular the different combinations of features that are defined by the sequentially numbered embodiments below:
1. An attachment unit (20) that is mountable on a rear region (14) of a body (12) of a motor vehicle (10), comprising a bearing unit (30), which is mountable in a manner fixed to the vehicle on the rear region (14) of the motor vehicle (10), in particular a passenger car, by a carrier unit (22), and by which a receiving body (32) that comprises an insertion receptacle (34) is held on the carrier unit (22) and is mounted such that it is movable between a working position (A) and a rest position (R), wherein in the working position (A) the insertion receptacle (34) extends with its center axis (36) approximately parallel to a vertical longitudinal center plane (40) of the attachment unit (20), wherein on movement from the working position (A) into the rest position (R) and vice versa the receiving body (32) moves parallel to a movement plane (70) and maintains a constant orientation of the center axis (36) of the insertion receptacle (34) transverse to the movement plane (70), and wherein the movement plane (70) runs transversely to a vertical longitudinal center plane (40).
2. The attachment unit according to embodiment 1, wherein the movement plane (70) forms an angle in the range of from 90° to 60° with one of the sides of the vertical longitudinal center plane (40).
3. The attachment unit (20) according to one of the preceding embodiments, wherein the movement plane (70) runs transversely to a horizontal longitudinal plane (72).
4. The attachment unit (20) according to embodiment 1 or 2, wherein the movement plane (70) forms an angle in the range of from 90° to 60° with one of the sides of the horizontal longitudinal plane (72).
5. The attachment unit (20) according to one of the preceding embodiments, wherein the receiving body (32) is movable from the working position (A) into the rest position (R) and vice versa only parallel to the movement plane (70).
6. The attachment unit (20) according to one of the preceding embodiments, wherein the bearing unit (30) comprises a guide unit (68) that determines a track for the receiving body (32) between the working position (A) and the rest position (R) that runs parallel to the movement plane (70).
7. The attachment unit according to one of the preceding embodiments, wherein the bearing unit (30) has a fixing device (66) by which the receiving body (32) is fixable in the working position (A) relative to the carrier unit (22).
8. The attachment unit (20) according to one of the preceding embodiments, wherein the bearing unit (30) has a fixing device (66) by which the receiving body (32) is fixable in the rest position (R) relative to the carrier unit (22).
9. The attachment unit (20) according to one of the preceding embodiments, wherein the attachment unit (20) has a bumper unit (16), which covers the carrier unit (22) and the bearing unit (30) on a side facing away from the rear region (14) of the body (12) and which has a bumper lower edge (44) facing a road (42), and wherein the insertion receptacle (34) is arranged, in the working position (A), on a side of the lower edge (44) of the bumper unit (16) that faces the road (42).
10. The attachment unit (20) according to one of the preceding embodiments, wherein the insertion receptacle (34) is arranged, in the rest position (R), on a side of the bumper lower edge (44) that faces away from the road (42).
11. The attachment unit (20) according to one of the preceding embodiments, wherein the receiving body (32), on movement from the working position (A) into the rest position (R) and vice versa, is movable through a free space between the bumper lower edge (44) and the rear region (14).
12. The attachment unit (20) according to one of the preceding embodiments, wherein the bumper unit (16) has a lower wall (102) which runs from the lower edge (44) thereof to the rear region (14) and is provided with an opening (108) through which the receiving body (32), with the insertion receptacle (34), is movable on movement from the working position (A) into the rest position (R) or vice versa.
13. The attachment unit (20) according to one of the preceding embodiments, wherein the bearing unit (30) comprises a pivotal unit (58) of which the pivot axis (60) is oriented perpendicular to the movement plane (70).
14. The attachment unit (20) according to embodiment 13, wherein the pivotal unit (58) has a pivot bearing unit (64) and a pivotal element (62), which is pivotal relative to this about the pivot axis (60) and on which the receiving body (32) is held.
15. The attachment unit (20) according to embodiment 14, wherein the receiving body (32) is connected to the pivotal element (62) either directly or by a connection element.
16. The attachment unit (20) according to one of embodiments 13 to 15, wherein a fixing device (66) is associated with the pivot bearing unit (64), in particular is integrated into it.
17. The attachment unit (20) according to embodiment 16, wherein the fixing device (66) takes the form of a rotation-blocking device.
18. The attachment unit (20) according to embodiment 17, wherein the fixing device (66) has at least one rotation-blocking body (118) that is movable in a guide direction (122) having at least one component in the radial direction in relation to the pivot axis (60), and wherein as a result of movement in the guide direction (122) the at least one rotation-blocking body (118) is engageable with and disengageable from at least one receptacle (124), and wherein an actuation body (126) that is movable in an actuation direction is provided, the movement of which in the actuation direction is configured to move and urge the at least one rotation-blocking body (118) in the guide direction (122), in order to move the rotation-blocking body (118) between at least one rotation-blocking position and a free-running position.
19. The attachment unit (20) according to embodiment 18, wherein, during its movement in the guide direction (122), the rotation-blocking body (118) is guided by guiding receptacles (116) in a guide body (110).
20. The attachment unit (20) according to one of embodiments 13 to 19, wherein the pivot bearing unit (64) is provided with a drive unit (80) for actuating the fixing device (66).
21. The attachment unit (20) according to one of embodiments 13 to 20, wherein the pivot bearing unit (64) is provided with a drive unit (80) for performing the pivotal movement of the pivotal element (62).
22. The attachment unit (20) according to one of the preceding embodiments, wherein the bearing unit (30) has a non-pivotal guide unit (130, 140) for moving the receiving body (32) along a track parallel to the movement plane (70).
23. The attachment unit (20) according to embodiment 22, wherein the guide unit takes the form of a linear guide (130, 140).
24. The attachment unit (20) according to one of embodiments 22 or 23, wherein the guide unit (130, 140) has a threaded spindle (138) as the driving element.
25. The attachment unit (20) according to one of embodiments 22 to 24, wherein the guide unit (130, 140) is provided with a fixing device (66′).
26. The attachment unit (20) according to embodiment 25, wherein the fixing device (66′) has a threaded spindle (138) that is configured to be self-locking.
27. The attachment unit (20) according to one of the preceding embodiments, wherein the receiving body (32) has at least two receiving body parts (32a, 32b, 32c), and wherein the receiving body parts (32a, 32b and 32c) together make up the receiving body (32) in the working position (A).
28. The attachment unit (20) according to embodiment 27, wherein the receiving body parts (32a, 32b, 32c) are movable parallel to the movement plane (70) along different guide tracks.
29. The attachment unit (20) according to one of the preceding embodiments, wherein the receiving body parts (32a, 32b, 32c) are movable into different rest positions (R).
30. The attachment unit (20) according to one of the preceding embodiments, wherein the receiving body parts (32a, 32b, 32c) are movable into the different rest positions (R) starting from the working position (A).
31. The attachment unit (20) according to one of the preceding embodiments, wherein a plug connector unit (84) is held on the receiving body (32).
32. The attachment unit (20) according to embodiment 31, wherein the plug connector unit (84), with the receiving body (32), is movable from a working position (A) into a rest position (R).
33. The attachment unit (20) according to embodiment 31 or 32, wherein the plug connector unit (84) has an insertion direction (86) for a plug connector which runs transversely to the movement plane (70).
34. The attachment unit (20) according to one of embodiments 31 to 33, wherein the plug connector unit (84) has an insertion opening (88) which, in the working position (A), is arranged on a side of the lower edge (44) of the bumper unit (16) that faces the road (42).
35. The attachment unit (20) according to one of embodiments 31 to 34, wherein, in the working position (A), the plug connector unit (84) extends away from the insertion opening (88) in the direction of the road (42).
36. The attachment unit (20) according to one of embodiments 31 to 35, wherein the plug connector unit is arranged, in the rest position (R), on a side of the lower edge (44) of the bumper unit (16) that faces away from the road (42).

Further features and advantages of the invention form the subject matter of the description below of some exemplary embodiments, and their representation in the drawing.

### BRIEF DESCRIPTION OF THE DRAWINGS

FIG. 1 shows a side view of a motor vehicle in the rear region, with a bumper unit and a first exemplary embodiment of an attachment unit according to the invention;

FIG. 2 shows a plan view, seen from the rear and looking in the direction of travel, of the first exemplary embodiment of the attachment unit according to the invention, in the working position;

FIG. 3 shows a view similar to FIG. 2, in the rest position;

FIG. 4 shows a perspective illustration of the first exemplary embodiment of the attachment unit according to the invention, in the working position;

FIG. 5 shows a perspective illustration of the first exemplary embodiment of the attachment unit according to the invention, in the rest position;

FIG. 6 shows a side view of the first exemplary embodiment of the attachment unit according to the invention along the line 6-6 in FIG. 4;

FIG. 7 shows a plan view from above of the first exemplary embodiment of the attachment unit according to the invention, corresponding to the line 7-7 in FIG. 4;

FIG. 8 shows a perspective illustration of the first exemplary embodiment of the attachment unit according to the invention, in the working position, in conjunction with the bumper unit;

FIG. 9 shows a perspective view, similar to FIG. 8, of the first exemplary embodiment of the attachment unit according to the invention, in the rest position;

FIG. 10 shows a perspective illustration of a second exemplary embodiment of an attachment unit according to the invention, integrated into a second exemplary embodiment of a bumper unit according to the invention, in the working position;

FIG. 11 shows a perspective illustration of the second exemplary embodiment of the attachment unit according to the invention in FIG. 10, in the rest position;

FIG. 12 shows an illustration, similar to FIG. 6, of a third exemplary embodiment of an attachment unit according to the invention, having a course that is inclined in relation to one side of the horizontal longitudinal plane;

FIG. 13 shows an illustration, similar to FIG. 6, of a variant of the third exemplary embodiment of the attachment unit according to the invention, having a course that is inclined in relation to a different side of the horizontal longitudinal plane;

FIG. 14 shows an illustration, similar to FIG. 7, of the third exemplary embodiment of the attachment unit according to the invention, having a course that is inclined in relation to one side of the vertical longitudinal center plane;

FIG. 15 shows an illustration, similar to FIG. 14, of a variant of the third exemplary embodiment of the attachment unit according to the invention, having a course that is inclined in relation to a different side of the vertical longitudinal center plane;

FIG. 16 shows an illustration of a further variant of the third exemplary embodiment;

FIG. 17 shows an illustration of an embodiment of a pivotal unit in the case of the first to third exemplary embodiments;

FIG. 18 shows an illustration, similar to FIG. 2, of a fourth exemplary embodiment of an attachment unit according to the invention;

FIG. 19 shows a side view along the line 19-19 in FIG. 18 of the fourth exemplary embodiment of the attachment unit according to the invention;

FIG. 20 shows a plan view, similar to FIG. 2, of a fifth exemplary embodiment of an attachment unit according to the invention; and

FIG. 21 shows a side view of a receiving body of the fifth exemplary embodiment of the attachment unit according to the invention.

### DETAILED DESCRIPTION OF THE INVENTION

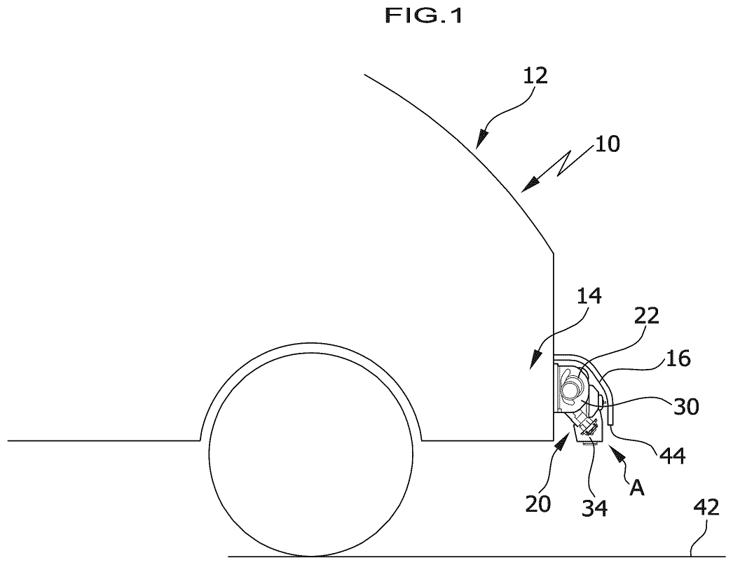

A first exemplary embodiment, illustrated in FIG. 1, of a motor vehicle 10 according to the invention comprises a body 12 that carries a rear bumper unit 16 on a rear region 14.

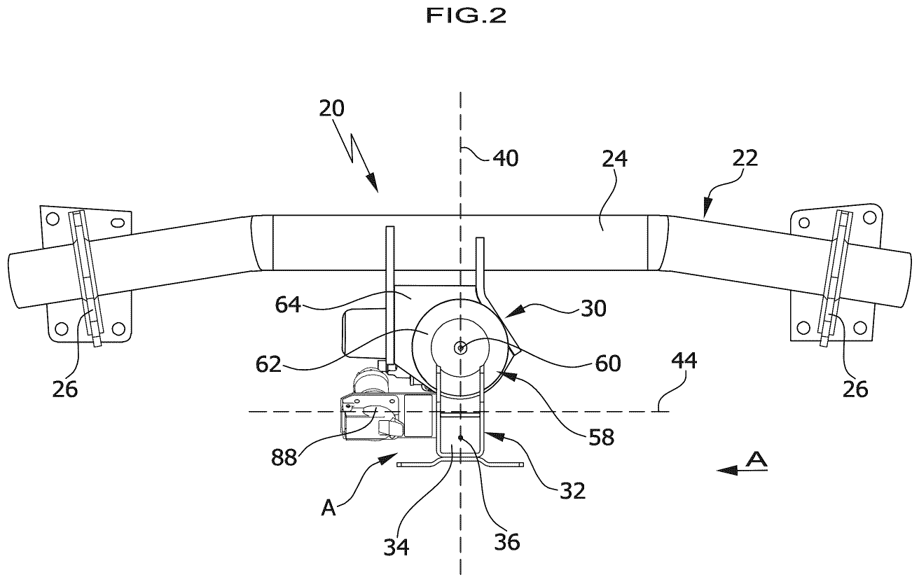

Further, arranged on the rear region 14 is a first exemplary embodiment of an attachment unit, which is designated 20 as a whole, and which for example also comprises the bumper unit 16 and has a carrier unit 22 that is arranged such that it is hidden by the bumper unit 16, wherein the carrier unit 22 comprises, as illustrated in FIG. 2, a transverse carrier 24 that is connected to the rear region 14 by lateral connection elements 26.

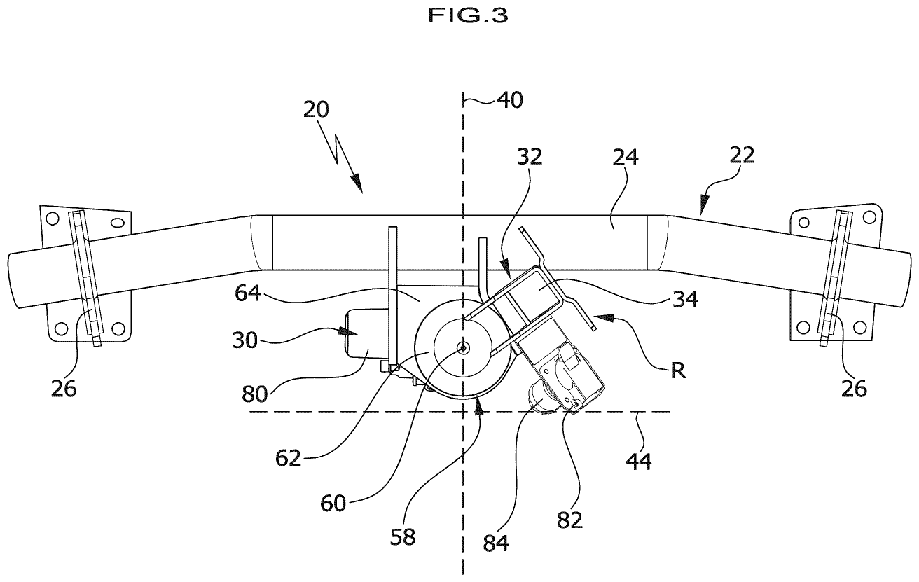

Moreover, connected to the carrier unit 22 is a bearing unit, which is designated 30 as a whole and by which a receiving body 32 is connected to the carrier unit 22, wherein arranged in the receiving body 32 is an insertion receptacle 34 that is movable from a working position A illustrated in FIG. 2 into a rest position R illustrated in FIG. 3, wherein in the working position A a center axis 36 of the insertion receptacle 34 extends approximately parallel to a vertical longitudinal center plane 40 of the attachment unit 20.

Preferably here, the vertical longitudinal center plane 40 of the attachment unit 20 is arranged such that it coincides with a vertical longitudinal center plane of the body 12, wherein the vertical longitudinal center plane 40 runs parallel to an X and a Z direction of the body 12 and in particular vertically in relation to a horizontal road 42 when the motor vehicle 10 provided with the attachment unit 20 is standing on this horizontal road 42.

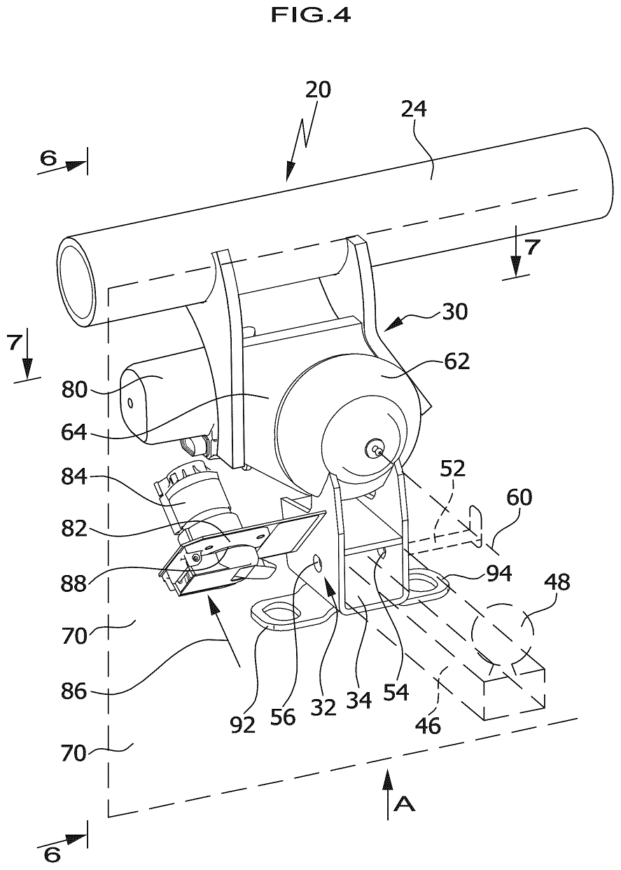

Further, in the working position A, as illustrated in FIGS. 1 and 2, the receiving body 32, with the insertion receptacle 34, is arranged such that the insertion receptacle 34 lies on a side of a lower edge 44 of the bumper unit 16, which is arranged to face away from the rear region 14 of the body 12, namely a side that faces the road 42, with the result that, as illustrated in FIG. 2, in the working position A the insertion receptacle 34 is accessible from a side of the bumper unit 16 facing away from the rear region 14 and from underneath this, in order for example to enable a holding arm 46 to be inserted into the insertion receptacle 34, wherein, as illustrated in FIG. 4, the holding arm 46 carries for example a coupling ball 48.

However, the holding arm 46 may also be a holding arm of a load carrier, in particular a bicycle carrier, that is insertable into the insertion receptacle 34.

In either case, the holding arm 46 is fixable in the insertion receptacle 34 for example by a transverse pin 52, wherein the transverse pin 52 passes through mutually opposing receiving openings 54 and 56 in the receiving body 32 and moreover, for the purpose of fixing the holding arm 46, also passes through the holding arm 46 that is inserted into the insertion receptacle 34 (FIG. 4).

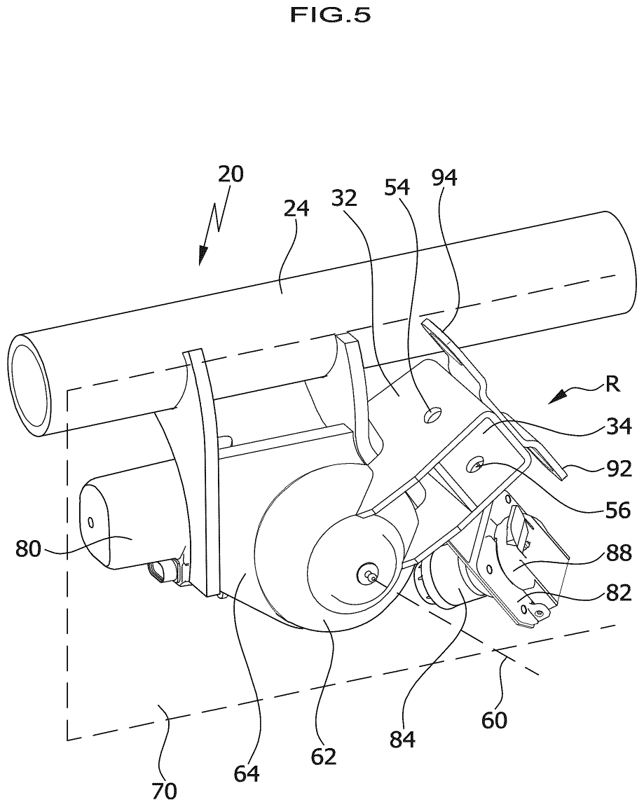

For the purpose of moving the receiving body 32 with the insertion receptacle 34 from the working position A illustrated in FIGS. 2 and 4 into the rest position R illustrated in FIG. 3, the receiving body 32 is held on a pivotal element 62 of the bearing unit 30, which takes the form of a pivotal unit 58, wherein the pivotal element 62 is pivotal relative to an unmoving pivot bearing unit 64 about a pivot axis 60 in order to move from the working position A illustrated in FIGS. 2 and 4 and arrive at the rest position R illustrated in FIGS. 3 and 5.

During the pivotal movement of the pivotal element 62, with the receiving body 32 and the insertion receptacle 34, about the pivot axis 60, the receiving body 32, with the insertion receptacle 34, moves parallel to a movement plane 70, wherein the movement plane 70 runs perpendicular to the pivot axis 60, with the result that the pivotal unit 58 is a guide unit 68 for the receiving body 32.

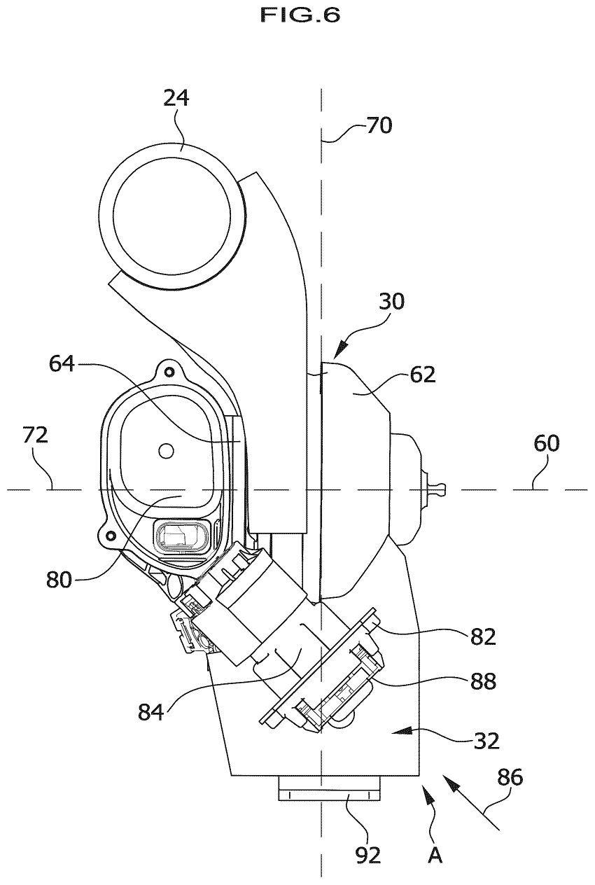

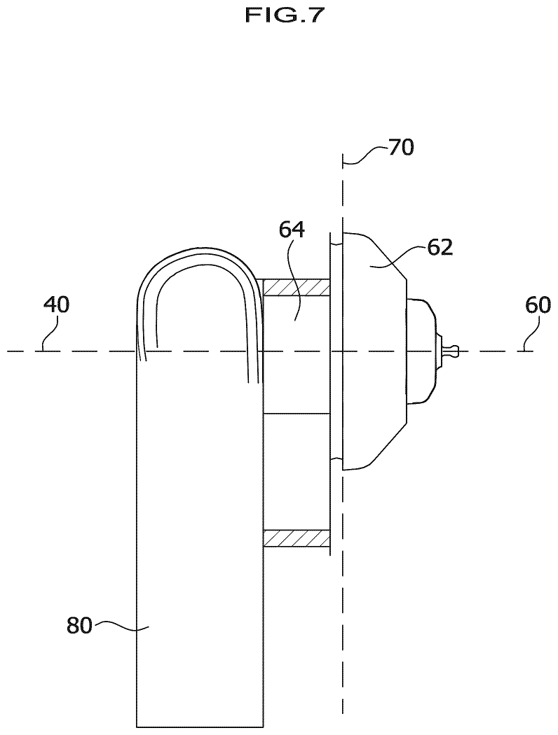

As illustrated in connection with the first exemplary embodiment, in particular in FIGS. 2 and 3, the pivot axis 60 lies for example in the vertical longitudinal center plane 40, and, as illustrated in particular in FIG. 7, the movement plane 70 runs perpendicular to the vertical longitudinal center plane 40 and, as illustrated in particular in FIG. 6, runs perpendicular to a horizontal plane 72 of the attachment unit 20 which is parallel to an X and a Y direction of the body 12 and applies in particular if the attachment unit 20 is mounted on the motor vehicle 10 and the motor vehicle is standing on the horizontal road 42.

However, the pivot axis 60 may for example also lie laterally next to the vertical longitudinal center plane 40 and run for example parallel thereto and in this case moreover run in the horizontal plane 72.

The pivotal movement of the pivotal element 62 relative to the pivot bearing unit 64 is performed with the holding arm 46 removed from the insertion receptacle 34, and may be performed either manually or by a drive unit 80 that is associated with the pivot bearing unit 64.

Moreover, the pivot bearing unit 64 is also provided with a fixing device 66 (not illustrated in the drawings) which makes it possible to fix the pivotal element 62 in relation to the pivot bearing unit 64 in both the working position A and the rest position R.

For the purpose of making an electrical connection between the electrical power supply of the motor vehicle 10 and for example a trailer or a load carrier unit, arranged on the pivotal element 62, in particular on the receiving body 32, is a carrier 82 on which there is held a plug connector unit 84 into which a connection plug is insertable in an insertion direction 86 running transversely, in particular obliquely, to the movement plane 70, for example at an acute angle thereto, wherein an insertion opening 88 in the plug connector unit 84 is arranged such that, in the working position A of the receiving body 32 with the insertion receptacle 34, it lies on a side of the lower edge 44 of the bumper unit 16 facing away from the rear region 14 that faces the road 42, and thus makes it possible to insert the plug connector in a simple manner.

However, movement of the receiving body 32, with the insertion receptacle 34, into the rest position is performed such that, in the rest position R, the carrier 82 with the plug connector unit 84 lies on a side of the lower edge 44 of the bumper unit 16 that faces away from the road 42, and is thus covered by the bumper unit 16, as illustrated in FIG. 3.

Moreover, as discernible in particular in FIGS. 4 and 5, in the working position holding eyelets 92, 94 are arranged on mutually opposite sides, for example on a side of the receiving body 32 facing the road 42, and these are likewise pivotal with the receiving body 32 from the working position A illustrated in FIG. 4 into the rest position R illustrated in FIG. 5, and in the rest position R likewise lie on a side of the lower edge 44 of the bumper unit 16 facing away from the road 42.

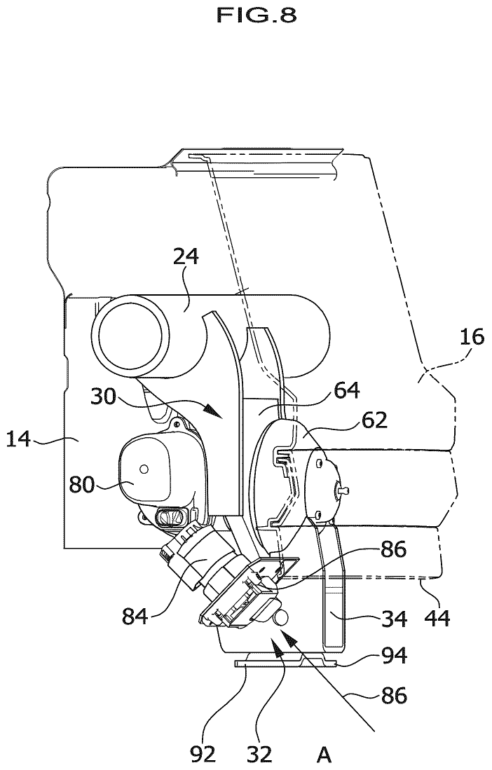

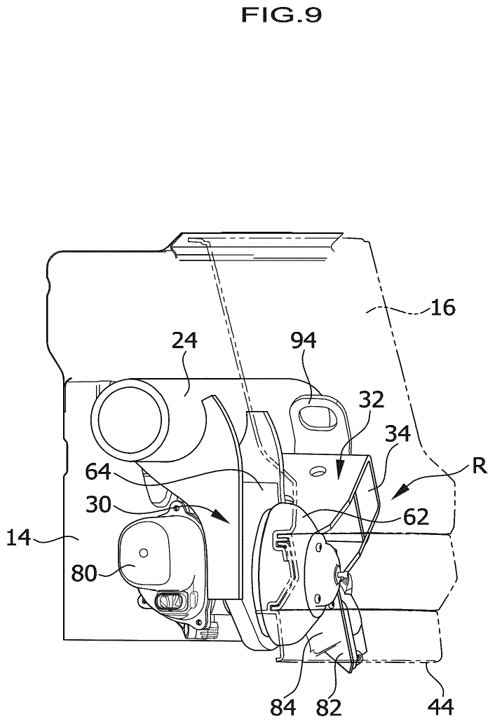

In order to show clearly the location of the working position A and the rest position R in relation to the bumper unit 16, FIGS. 8 and 9 illustrate a detail of the rear region 14 of the body 12 and the part of the bumper unit 16 facing away from the rear region 14, with its lower edge 44, such that it is discernible from this that in the working position A the insertion receptacle 34 of the receiving body 32 and the insertion opening 88 of the plug connector unit 84 lie below the lower edge 44 of the bumper unit 16 and thus on a side thereof facing the road 42, and moreover that the holding eyelets 92 and 94 are arranged below the lower edge 44 of the bumper unit 16, while in the rest position R the receiving body 32 with the insertion receptacle 34, the carrier 82 with the plug connector unit 84 and moreover the holding eyelets 92 and 94 lie on a side of the lower edge 44 of the bumper unit 16 that faces away from the road 42 and are thus hidden from view by the region part of the bumper unit 16 that faces away from the rear region 14, as seen in the direction from a rear side toward the motor vehicle 10.

In order in particular to prevent the holding eyelets, in particular the holding eyelet 94, from colliding with the transverse carrier 24 in the rest position R, the pivot bearing 64 of the bearing unit 30 is arranged in relation to the transverse carrier 24 such that at least the holding eyelet 94 but in particular also the receiving body 32 with the insertion receptacle 34 are positioned such that they are collision-free relative to the transverse carrier 24 in the rest position R, that is to say for example either between the transverse carrier 24 and the bumper unit 16, as illustrated in the drawing of FIG. 9, or conversely between the transverse carrier 24 and the rear region 14 of the body 12, such that in this case the transverse carrier 14 lies close to the part of the bumper unit 16 that faces away from the rear region 14.

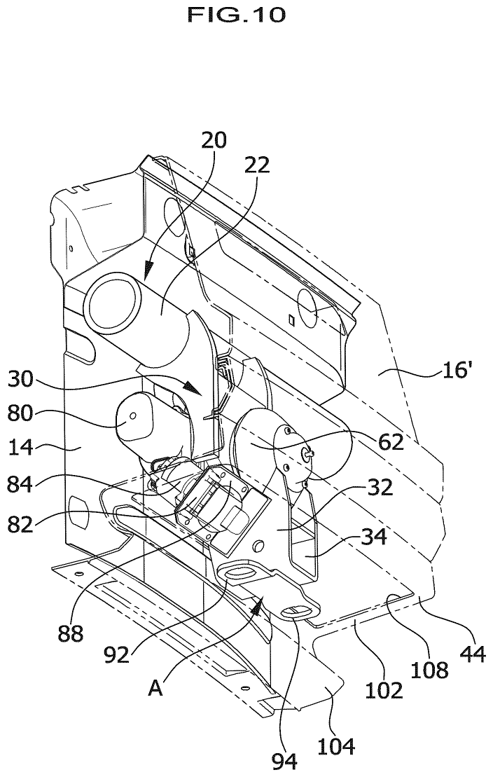

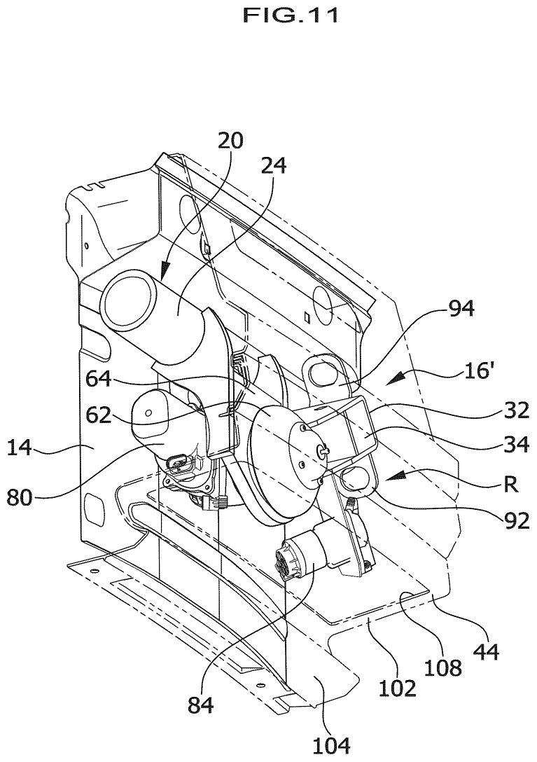

In a second exemplary embodiment, illustrated in FIGS. 10 and 11, the carrier unit 20 with the transverse carrier 24 and the bearing unit 30, the pivotal element 62 and the pivot bearing unit 64 with the receiving body 32 and the insertion receptacle 34 are arranged in the same way as in the first exemplary embodiment, so the same reference numerals are used, and otherwise reference is made to the statements regarding the first exemplary embodiment in their entirety.

In contrast to the first exemplary embodiment, the part of the bumper unit 16′ that faces away from the rear region 14 runs down to the lower edge 44 and from there runs in the direction of the rear region 14 by way of a lower wall 102, wherein the lower wall 102 is connected to the rear region 14 again by way of a lower terminating region 104.

In order to enable access to the insertion receptacle 34 in the working position A, the lower wall 102 is provided with an opening 110 through which reach the receiving body 32 with the insertion receptacle 34, the holding eyelets 92 and 94 and also the plug connector unit 84 with the insertion opening 88, in order to ensure accessibility to the insertion receptacle 34, the holding eyelets 92 and 94 and the insertion opening 88.

For the purpose of moving the receiving body 32 with the insertion receptacle 34, the carrier 82 with the plug connector unit 84, and the holding eyelets 92 and 94 into the rest position, the opening 108 is dimensioned such that on a pivotal movement about the pivot axis 60 these elements can be moved through the opening 108 and into the rest position R in a collision-free manner, in order to be out of sight there as a result of the part of the bumper unit 16 that faces away from the rear region 14.

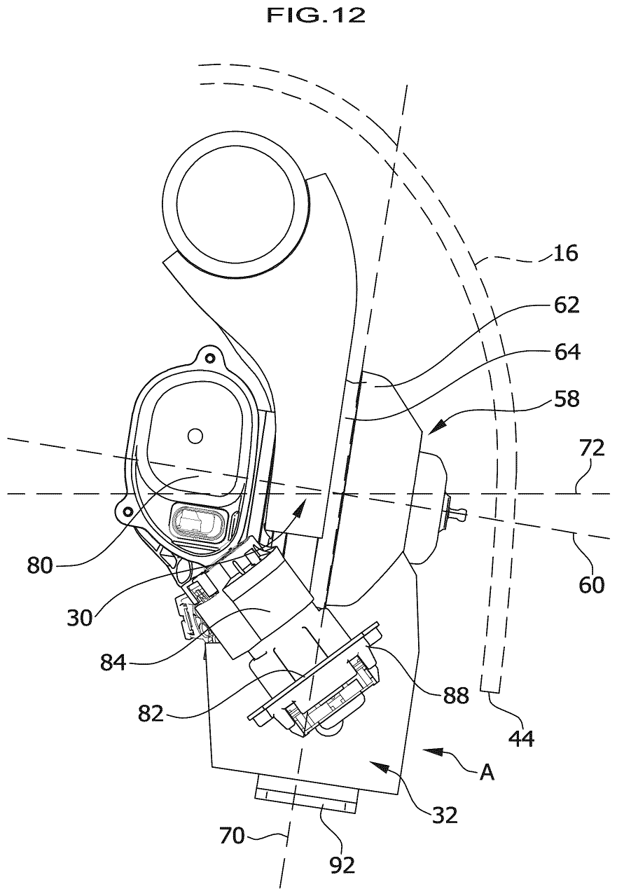

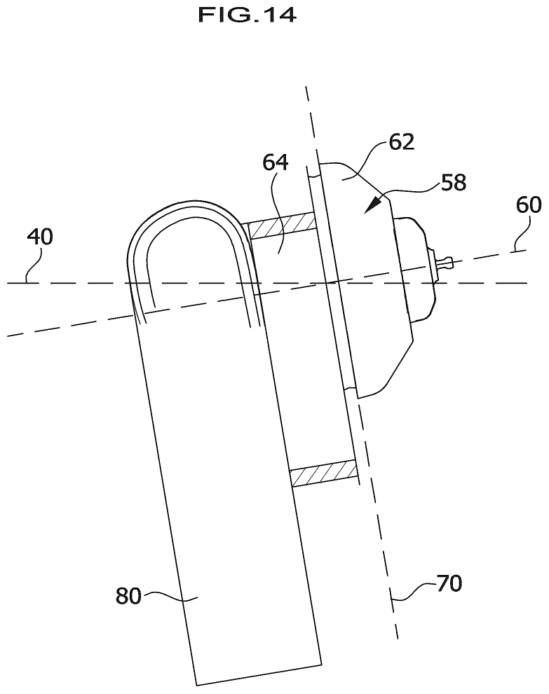

In a third exemplary embodiment, illustrated in FIGS. 12, 14 and 13, 15, which show the same views as FIGS. 6 and 7, the pivot axis 60 does not necessarily run parallel to the vehicle longitudinal center plane 40 and the horizontal plane 72, but may run at an angle to these, as discernible in FIG. 12 and FIG. 14, such that the movement plane 70, which runs perpendicular to the pivot axis 60, may form an angle with the vertical longitudinal center plane 40 and/or the horizontal plane 72 that may lie in the range of from 90°, as in the illustrations in FIGS. 6 and 7, to 60°, or better in the range of from 90° to 65°, more advantageously in the range of from 90° to 70° and preferably in the range of from 90° to 75°, in order to be able to optimally adapt the movement of the receiving body 32 with the insertion receptacle 34, the plug connector unit 84 with the carrier 82, and the holding eyelets 92 and 94 to the spatial conditions between the rear region 14 and the part of the bumper unit 16 facing away from the rear region 14.

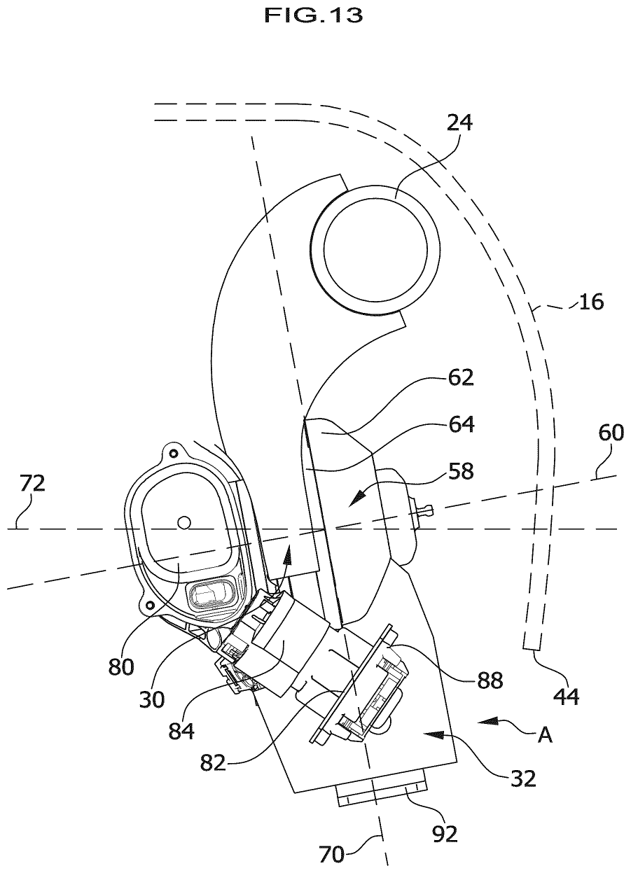

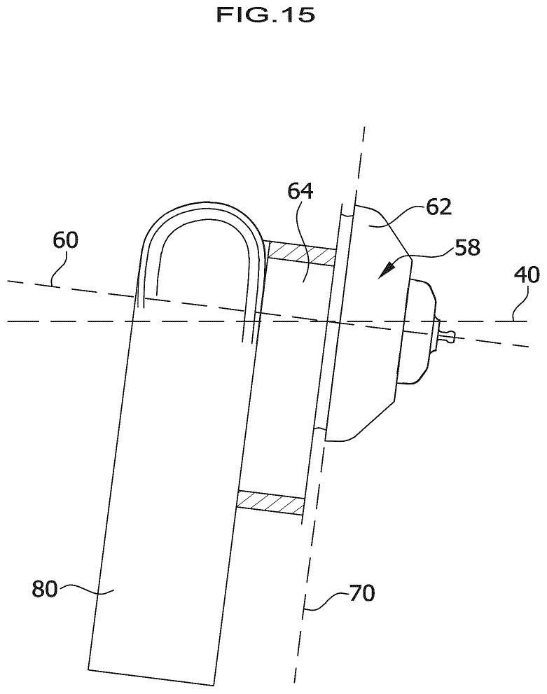

However, it is also conceivable to arrange the transverse carrier 24 on a side facing away from the rear region 14, as illustrated in FIGS. 13 and 15, and to form, between the horizontal longitudinal plane 72 and/or the vertical longitudinal center plane 40 on the one hand and the movement plane 70 on the other, an angle pointing in the other direction and with the same ranges as explained in conjunction with FIGS. 12 and 14.

Forming an angle between the movement plane 70 on the one hand and the longitudinal center plane 40 and/or the horizontal longitudinal plane 72 on the other makes it possible to optimally adapt the space taken up in the working and the rest positions to the spatial conditions between the rear region 14 and the bumper unit 16.

Preferably, however, in this exemplary embodiment too it is provided for the center axis 36 of the insertion receptacle 34 to lie in the vertical longitudinal center plane 40 in the working position A.

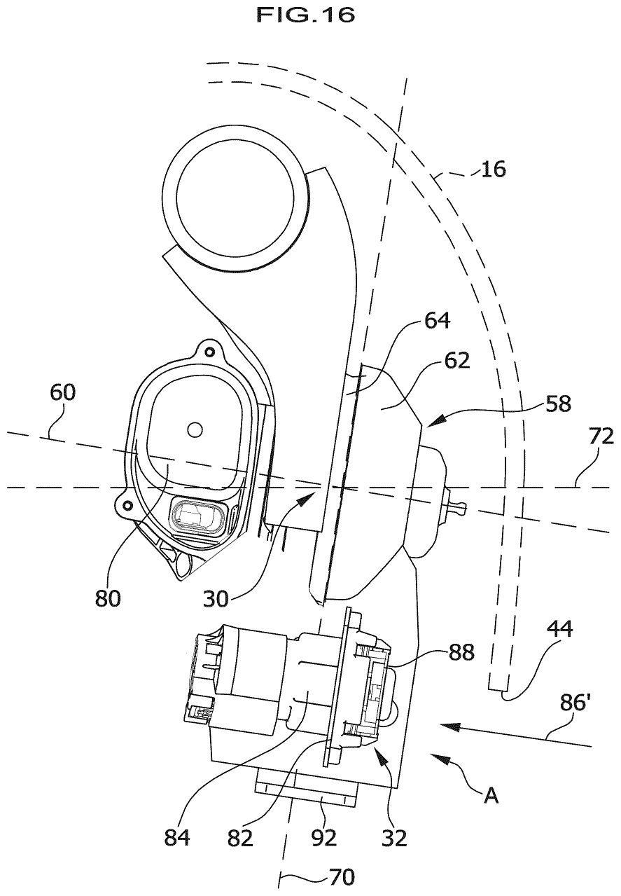

In a further variant of the third exemplary embodiment, illustrated in FIG. 16, and as a modification to the illustration of FIG. 12, the plug connector unit 84 is arranged such that in the working position A of the receiving body 32 as a whole, and thus also including the insertion receptacle 34, the plug connector unit 84 lies on a side of the lower edge 44 of the bumper unit 16 facing away from the rear region that faces the road 42, such that the insertion direction 86′ runs transversely to the movement plane, in particular approximately perpendicular thereto, wherein the plug connector is movable below the lower edge 44 in a collision-free manner.

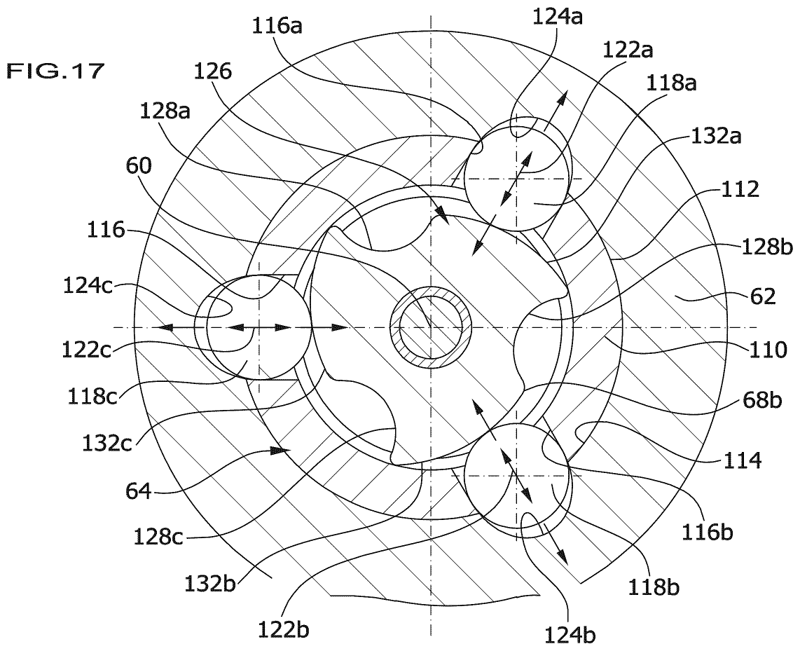

In all the above exemplary embodiments of the pivotal unit 58, the pivotal element 62 is mounted on the pivot bearing unit 64 to pivot about the pivot axis 60, wherein the pivot bearing unit 64 has, as illustrated in FIG. 17, a guide body 110 that is a fixed constituent part of the bearing unit 30 and is also connected to the transverse carrier 24, and at the same time

has an outer face 112 which runs cylindrically in relation to the pivot axis 60 and on which the pivotal element 62 is mounted with an inner face 114 that likewise runs cylindrically in relation to the pivot axis 60, wherein the pivotal element 62 is thus mounted to rotate about the pivot axis 60.

For example, integrated in the pivot bearing unit 64 is the fixing device 66 in the form of a rotation-blocking device that has rotation-blocking bodies 118a, 118b and 118c which are guided in guiding receptacles 116a, 116b and 116c in the guide body 110 and which are each movable in a radial guide direction 122a, 122b and 122c relative to the pivot axis 60 and are configured to be brought into engagement with a first set of receptacles 124a, 124b and 124c, for example in the working position A, in which case the rotation-blocking bodies 118a, 118b and 118c engage in the receptacles 124a, 124b and 124c.

Once the pivotal element 62 has rotated from the working position A into the rest position R, the rotation-blocking bodies 118a, 118b and 118c engage in the receptacles 124c, 124a and 124b in order likewise once again to fix the pivotal element 62 in relation to the pivot bearing unit 64.

Here, the radial movement of the rotation-blocking bodies 118a, 118b and 118c is triggered by an actuation body 126 which is mounted within the guide body 100, likewise such that it is rotatable about the pivot axis 60, and which is provided with a set of in total for example three retraction receptacles 128a, 128b and 128c into which the rotation-blocking bodies 118a can penetrate in a free-running position in order to disengage from the receptacles 124, and which is moreover provided with pressure faces 132a, 132b and 132c that adjoin the retraction receptacles 128 and by which, on rotation of the actuation body 126 about the pivot axis 60, the rotation-blocking bodies 118 are movable into and pressable within the receptacles 124 and are thus movable into a rotation-blocking position, such that, with a fixing device 66 of this kind, locking of the pivotal element 62 in relation to the pivot bearing unit 64 is achievable in both the working position A and also the rest position R.

For example, moreover, drives operating by a similar principle for the pivotal element 62 and having a drive for the fixing unit 66 in the working position A and the rest position R are described in detail in European patent applications EP 2 266 820 A, EP 2 837 514 A, EP 3 141 405 A or EP 1 477 340 A, wherein reference is additionally made to this description.

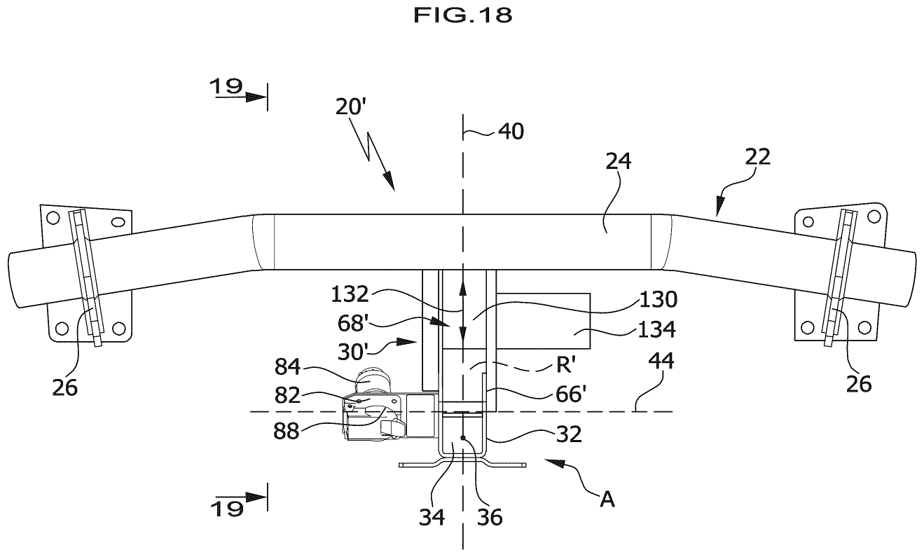

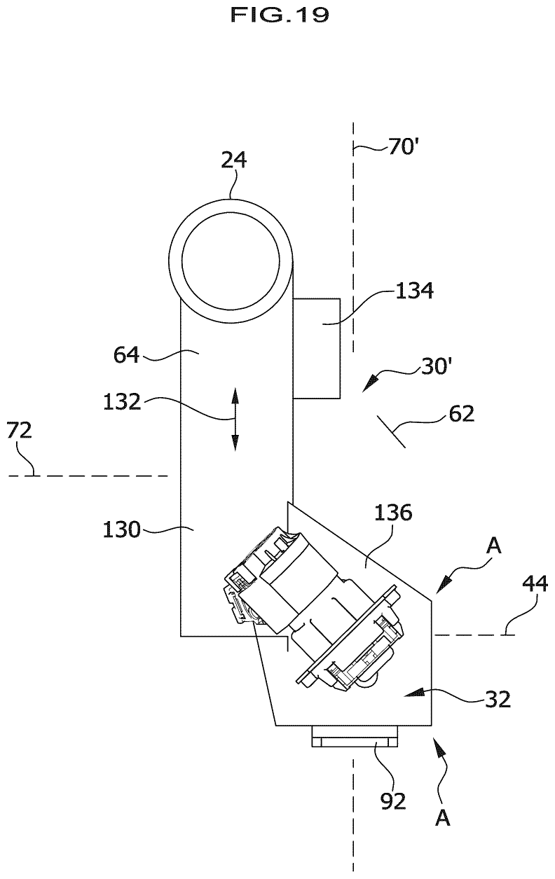

In a fourth exemplary embodiment, illustrated in FIGS. 18 and 19, the bearing unit 30′ takes the form of a vertical displacement unit 130 which makes it possible to displace the receiving body 32, with the insertion receptacle 34 and the holding eyelets 92 and 94 and the plug connector unit 84, along a linear track parallel to the movement plane 70′, for example in a vertical direction 132, out of the working position A, such that in the rest position R′ the receiving body 32, with the insertion receptacle 34, the holding eyelets 92 and 94 and the carrier 82 and the plug connector unit 84, lies on a side of the lower edge 44 of the bumper unit 16 that faces away from the road 42, and is thus moved out of the visible region.

For this purpose a drive unit 134 is for example provided.

Here, the vertical displacement unit 130 is provided for example with a threaded spindle that is configured to be self-locking and that serves as a drive element of the displacement unit 130 and as a fixing device 66′ a slide element 136 holding the receiving body 32.

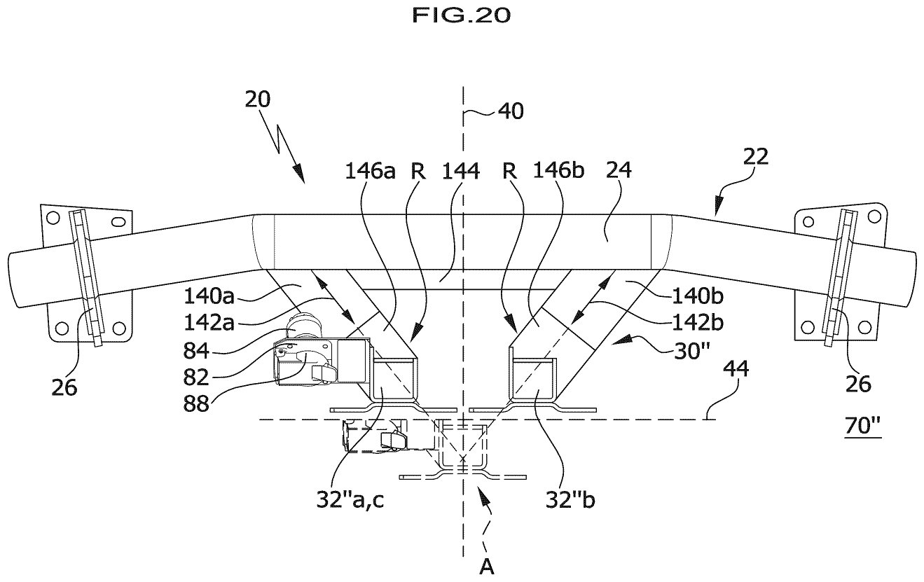

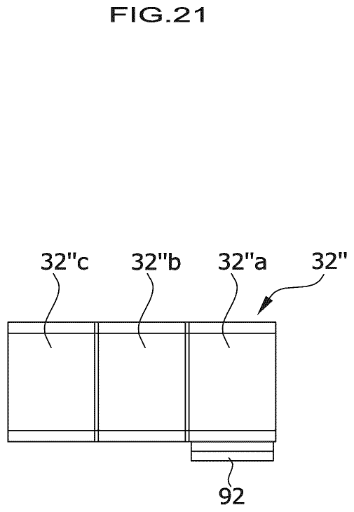

In a fifth exemplary embodiment, illustrated in FIGS. 20 and 21, the bearing unit 30″ comprises two displacement units 140a and 140b which run obliquely, for example in directions 142a, 142b that form a V shape with one another, in relation to the transverse carrier 24 and each carry one or more element parts of the receiving body 32″.

For example, provided on the displacement unit 140a is a slide element 146a, which holds the element parts 32a and 32c of the receiving body and as a result of which these are movable, parallel to a movement plane 70″ that runs in the plane of the drawing in FIG. 20, between the working position A, which is illustrated in broken lines, and a rest position R, illustrated in solid lines.

Further, a slide element 142b carries the element part 32b of the receiving body 32, and this is displaceable, parallel to a movement plane that runs in the plane of the drawing in FIG. 20, between the working position A, which is illustrated in broken lines, in which all the element parts 32a, 32b and 32c together make up the receiving body 32″, and a rest position R.

In the rest positions R, both the element parts 32a and 32c of the receiving body 32′″ that are held by the slide element 142a and also the element part 32b of the receiving body 32″ that is held by the slide element 142b lie on a side of the lower edge 44 of the bumper unit 16 that faces away from the road 42.

In the working position A, in which the element parts 32a, 32b and 32c are arranged flush with one another (FIG. 21) and form a common insertion receptacle 34, the receiving body 32″ lies on a side of the lower edge 44 of the bumper unit 16 that faces the road 42, such that a holding arm 46 is insertable into the insertion receptacle 34 of the receiving body 32″ and is held by all the element parts 32a, 32b and 32c, which are thus stabilized in relation to one another, while in the respective rest positions R the element parts 32a and 32c are moved by the displacement unit 140a and its slide element 142a to a side of the vertical longitudinal center plane 40, while the element part 32b is moved away by the displacement unit 140b, with the slide element 142b, into the rest position R on the opposite side of the vertical longitudinal center plane 40.

Dividing the receiving body 32″ into three element parts 32a, 32b and 32c has the advantage that in the working position A these are blocked in relation to one another and thus an additional blocking is possible in the working position, since the displacement units 130 run in a V shape on either side of the vertical longitudinal center plane 40 and thus the element parts 32a and 32c, and 32b, together form the receiving body 32 only in the working position A illustrated in broken lines.

In this exemplary embodiment too, the displacement units 140a and 140b are each provided with a drive unit or are jointly driven by a common drive unit 144, such that the movement of the element parts 32″a, c and 32″b is synchronous in the direction of the working position A and is likewise synchronous in the direction away from the working position A.

1. An attachment unit that is mountable on a rear region of a body of a motor vehicle, comprising a bearing unit, which is mountable in a manner fixed to the vehicle on the rear region of the motor vehicle, in particular a passenger car, by a carrier unit, and by which a receiving body that comprises an insertion receptacle is held on the carrier unit and is mounted such that it is movable between a working position and a rest position, wherein in the working position the insertion receptacle extends with its center axis approximately parallel to a vertical longitudinal center plane of the attachment unit, wherein on movement from the working position into the rest position and vice versa the receiving body moves parallel to a movement plane and maintains a constant orientation of the center axis of the insertion receptacle transverse to the movement plane, and wherein the movement plane runs transversely to a vertical longitudinal center plane.

2. The attachment unit as claimed in claim 1, wherein the movement plane forms an angle in the range of from 90° to 60° with one of the sides of the vertical longitudinal center plane.

3. The attachment unit as claimed in claim 1, wherein the movement plane runs transversely to a horizontal longitudinal plane.

4. The attachment unit as claimed in claim 1, wherein the movement plane forms an angle in the range of from 90° to 60° with one of the sides of the horizontal longitudinal plane.

5. The attachment unit as claimed in claim 1, wherein the receiving body is movable from the working position into the rest position and vice versa only parallel to the movement plane.

6. The attachment unit as claimed in claim 1, wherein the bearing unit comprises a guide unit that determines a track for the receiving body between the working position and the rest position that runs parallel to the movement plane.

7. The attachment unit as claimed in claim 1, wherein the bearing unit has a fixing device by which the receiving body is fixable in the working position relative to the carrier unit.

8. The attachment unit as claimed in claim 1, wherein the bearing unit has a fixing device by which the receiving body is fixable in the rest position relative to the carrier unit.

9. The attachment unit as claimed in claim 1, wherein the attachment unit has a bumper unit, which covers the carrier unit and the bearing unit on a side facing away from the rear region of the body and which has a bumper lower edge facing a road, and wherein the insertion receptacle is arranged, in the working position, on a side of the lower edge of the bumper unit that faces the road.

10. The attachment unit as claimed in claim 1, wherein the insertion receptacle is arranged, in the rest position, on a side of the bumper lower edge that faces away from the road.

11. The attachment unit as claimed in claim 1, wherein the receiving body, on movement from the working position into the rest position and vice versa, is movable through a free space between the bumper lower edge and the rear region.

12. The attachment unit as claimed in claim 1, wherein the bumper unit has a lower wall which runs from the lower edge thereof to the rear region and is provided with an opening through which the receiving body, with the insertion receptacle, is movable on movement from the working position into the rest position or vice versa.

13. The attachment unit as claimed in claim 1, wherein the bearing unit comprises a pivotal unit of which the pivot axis is oriented perpendicular to the movement plane.

14. The attachment unit as claimed in claim 13, wherein the pivotal unit has a pivot bearing unit and a pivotal element, which is pivotal relative to this about the pivot axis and on which the receiving body is held.

15. The attachment unit as claimed in claim 14, wherein the receiving body is connected to the pivotal element either directly or by a connection element.

16. The attachment unit as claimed in claim 13, wherein a fixing device is associated with the pivot bearing unit, in particular is integrated into it.

17. The attachment unit as claimed in claim 16, wherein the fixing device takes the form of a rotation-blocking device.

18. The attachment unit as claimed in claim 17, wherein the fixing device has at least one rotation-blocking body that is movable in a guide direction having at least one component in the radial direction in relation to the pivot axis, and wherein as a result of movement in the guide direction the at least one rotation-blocking body is engageable with and disengageable from at least one receptacle, and wherein an actuation body that is movable in an actuation direction is provided, the movement of which in the actuation direction is configured to move and urge the at least one rotation-blocking body in the guide direction, in order to move the rotation-blocking body between at least one rotation-blocking position and a free-running position.

19. The attachment unit as claimed in claim 18, wherein, during its movement in the guide direction, the rotation-blocking body is guided by guiding receptacles in a guide body.

20. The attachment unit as claimed in claim 13, wherein the pivot bearing unit is provided with a drive unit for actuating the fixing device.

21. The attachment unit as claimed in claim 13, wherein the pivot bearing unit is provided with a drive unit for performing the pivotal movement of the pivotal element.

22. The attachment unit as claimed in claim 1, wherein the bearing unit has a non-pivotal guide unit for moving the receiving body along a track parallel to the movement plane.

23. The attachment unit as claimed in claim 22, wherein the guide unit takes the form of a linear guide.

24. The attachment unit as claimed in claim 22, wherein the guide unit has a threaded spindle as the driving element.

25. The attachment unit as claimed in claim 22, wherein the guide unit is provided with a fixing device.

26. The attachment unit as claimed in claim 25, wherein the fixing device has a threaded spindle that is configured to be self-locking.

27. The attachment unit as claimed in claim 1, wherein the receiving body has at least two receiving body parts, and wherein the receiving body parts together make up the receiving body in the working position.

28. The attachment unit as claimed in claim 27, wherein the receiving body parts are movable parallel to the movement plane along different guide tracks.

29. The attachment unit as claimed in claim 1, wherein the receiving body parts are movable into different rest positions.

30. The attachment unit as claimed in claim 1, wherein the receiving body parts are movable into the different rest positions starting from the working position.

31. The attachment unit as claimed in claim 1, wherein a plug connector unit is held on the receiving body.

32. The attachment unit as claimed in claim 31, wherein the plug connector unit, with the receiving body, is movable from a working position into a rest position.

33. The attachment unit as claimed in claim 31, wherein the plug connector unit has an insertion direction for a plug connector which runs transversely to the movement plane.

34. The attachment unit as claimed in claim 31, wherein the plug connector unit has an insertion opening which, in the working position, is arranged on a side of the lower edge of the bumper unit that faces the road.

35. The attachment unit as claimed in claim 31, wherein, in the working position, the plug connector unit extends away from the insertion opening in the direction of the road.

36. The attachment unit as claimed in claim 31, wherein the plug connector unit is arranged, in the rest position, on a side of the lower edge of the bumper unit that faces away from the road.
